(19) United States
(12) Patent Application Publication
(10) Pub. No.: US 2010/0140830 A1
(43) Pub. Date: Jun. 10, 2010

(54) ROTARY DIE SUPPORT AND INSERT DIE MEMBER DEVICES AND METHODS FOR ENCAPSULATION TECHNOLOGIES

(76) Inventor: Aldo PERRONE, Brampton (CA)

Correspondence Address: FASKEN MARTINEAU DUMOULIN LLP, 4200 TORONTO DOMINION BANK TOWER, BOX 20 TORONTO-DOMINION CENTRE, TORONTO, ON, M5K 1N6, CA

(21) Appl. No.: 12/631,388

(22) Filed: Dec. 4, 2009

Related U.S. Application Data
(60) Provisional application No. 61/119,944, filed on Dec. 4, 2008.

(51) Int. Cl. B29C 43/18; B28B 3/14

(52) U.S. Cl. 264/153; 425/520

(57) ABSTRACT

A rotary die support and insert die device is for forming gel capsules and for use with a pair of gel ribbons and a fill material. The device includes rotary die supports and insert die members. The rotary die supports rotate towards one another. Each insert die member has a contact rim and inner and outer surfaces. The outer surface extends into an outwardly facing aperture in an exterior surface of one rotary die support. It securely engages the rotary die support in selectively removable relation. The inner surface has an outwardly facing cavity. The ribbons are juxtaposed between contact rims of opposing insert die members mounted on opposing rotary die supports. A web of gel material is formed from the ribbons, with the cavities of the insert die members forming encapsulated pocket portions in the web which are filled with the fill material.

### FIELD OF THE INVENTION

The present invention relates generally to rotary die encapsulation technologies, and more particularly, to rotary die support and insert die member devices and methods for encapsulation technologies.

### BACKGROUND OF THE INVENTION

Capsules are solid dosage forms in which fill materials are enclosed in a gel wall. The fill materials may include paintball fill materials and therapeutic agents, and at least in the case of the latter, the gel wall of prior art capsules has typically been formed as a soluble gelatin wall. The wall of a gelatin capsule can be made of either soft or hard gelatin. In the prior art, the gelatin may in some cases have been plasticized by the addition of additives such as glycerin, sorbitol, and/or similar types of polyols. Soft gelatin capsules have offered a convenient dosage form for the administration of drugs, nutrients, vitamins, foodstuff and cosmetics. Commercially available gelatin capsules have been provided in a variety of sizes and shapes, e.g., round, oval, oblong, tubular, and suppository-shaped.

In the prior art, gel capsules have typically been formed by joining two identical halves to form a shell encapsulating the fill material. Generally, prior art soft gelatin capsules have been prepared by the rotary-die process. In this process, soft gelatin capsules have been made by continuously casting two separate ribbons of molten or flowable gelatin into two separate rotary dies of an encapsulation machine to produce soft, elastic gelatin capsules. Four prior art patent references, namely, (i) U.S. Pat. No. 5,672,300 issued to Schurig et al. on Sep. 30, 1997 for a Method For Striping Or Marbleizing Capsules, (ii) U.S. Pat. No. 6,022,499 issued to Schurig et al. on Feb. 8, 2000 for a Method For Striping Or Marbleizing Capsules, (iii) U.S. Pat. No. 6,569,363 issued to Schurig et al. on May 27, 2003 for an Apparatus And Methods For Forming Patterned Soft Gelatin Capsules, and (iv) U.S. patent application Ser. No. 10/373,158 (Schurig et al.) for an Apparatus And Methods For Forming Patterned Soft Gelatin Capsules (published on Jul. 10, 2003 under U.S. Patent Publication No. 2003/0127760), provide a description of well known soft gelatin capsule art. The rotary die processes described in these references are incorporated herein by reference as being descriptive of the rotary die process to which the present invention is related.

Previously, dies used for encapsulation may have been manufactured from a solid piece of aluminum or steel. It may have taken considerable time to manufacture each die—e.g., in the order of about twelve (12) hours. If one of a pair of dies was damaged and/or worn on its landing surface, then previously, it may typically have been necessary for both of the dies to be re-machined and/or ground to provide a new pair of smooth mating landing surfaces—e.g., since both of the dies would ordinarily need to have the same diameter to produce properly finished goods. In some situations, it may heretofore even have been necessary to scrap the dies and produce entirely new ones, often at great expense. Apart from any expenses associated with the foregoing, it may have typically required a significant expenditure of time and/or effort to remove damaged and/or worn dies from a prior art encapsulating machine, and/or to replace them with new dies. In the prior art, when dies were removed and new ones were placed on encapsulation machines, it may generally have been necessary for the dies to be aligned, and/or to adjust the timing of the injection wedge and/or to synchronize the timing of the dies therewith. Previously, it may have been generally the case that any of the foregoing occurrences and/or disadvantages associated with the prior art may also have been concomitant with costly down time and/or loss of production.

What may be needed is an encapsulation technology which eliminates, minimizes and/or reduces the need to re-machine and/or grind a rotary die, if damage and/or wear occurs. Preferably, such an encapsulation technology would require replacement, re-machining and/or grinding of only those landing areas which are actually damaged and/or worn. It may also be desirable to enable this operation to be performed directly on an encapsulating machine—i.e., without having to remove the rotary dies—potentially, so as to save valuable production time. Preferably, the replacement of each damaged and/or worn landing surface would take only a short time (e.g., perhaps in the order of about a few seconds), without requiring re-alignment of the rotary die assemblies and/or re-timing of (or with) the injection wedge. What may also be needed is an encapsulation technology which enables worn and/or damaged landing surface members to be recycled—e.g., to reduce costs.

It may also be desirable to minimize and/or reduce the amount of time required to manufacture rotary dies. It may be advantageous to eliminate, minimize and/or reduce the contact—and/or likelihood of potentially damaging and/or wearing contact—between a pair of rotary dies. There may be some advantage to minimizing and/or reducing the operational damage and/or wear sustained by, and/or to increasing the lifespan of, rotary dies in an encapsulation machine. It may be desirable (i) to reduce the frequency of required rotary die replacement, (ii) to diminish any previous need to always keep a back-up pair of rotary dies on hand and at the ready, and/or (iii) to minimize any down time or disruption of business that might otherwise be associated with any of the foregoing.

Some prior art patent applications may have endeavored to solve vaguely similar problems—e.g., Canadian Patent Application No. 2,327,472 (Perrone) for a Machine For Enrobing Tablets With Gelatin (published on Oct. 21, 1999), and Canadian Patent Application No. 2,360,592 (Perrone) for a Feeding Mechanism For Machine For Enrobing Tablets (published on Aug. 3, 2000). In this respect, however, the prior art has only disclosed providing dies made of a series of die blocks, each of which had a series of recesses, with the die blocks were mounted on a die support. These prior art references continued to suffer from certain shortcomings which required removal of a full die block, and of the face plate, to change a single damaged recess. Such prior art methodologies required a significantly long period of time to change a single damaged recess. In addition, the die blocks in such prior art designs were not capable of forming an exact shape, but rather were only capable of being used to hold a tablet and to allow an enrobing material to shrink form around said tablet. Additionally, these prior art references use only permitted the enrobing of tablets, and not the production of liquid filled capsules.

Accordingly, and without limitation, it is an object of one or more aspects of the invention to provide an encapsulation technology which: (a) eliminates, minimizes and/or reduces the need to re-machine and/or grind a rotary die support, if damage and/or wear occurs; (b) requires replacement, re-machining and/or grinding of only those landing areas (hereinafter, alternately “contact surfaces”) which are actually damaged and/or worn; (c) enables replacement of contact surfaces to be performed in a short period of time directly on an encapsulating machine, without requiring removal of the rotary die supports, re-alignment of the rotary die supports, and/or re-timing the injection wedge; (d) eliminates, minimizes and/or reduces the contact between a pair of rotary die supports; (e) reduces the frequency of required rotary die support replacement; and/or (f) minimizes any potentially costly periods of down time and/or disruptions of business.

It is an object of the invention to obviate or mitigate at least one of the above mentioned disadvantages and/or problems associated with the prior art, and/or to achieve one or more of the aforementioned objects of the invention.

### SUMMARY OF THE INVENTION

According to the invention, there is disclosed a rotary die support and insert die device for forming gel capsules and for use with a pair of gel ribbons and a fill material. The device includes an adjacent pair of rotary die supports to rotate towards one another in opposing rotary directions. Each of the rotary die supports defines a longitudinal axis and each has a wall with an exterior surface. The exterior surface of at least one of the rotary die supports is shaped to define one or more outwardly facing apertures extending at least partially through the wall. The device also includes one or more insert die members. Each of the insert die members has an outer surface extending into a respective one of the apertures and securely engaging a respective one of the rotary die supports in selectively removable relation. Each of the insert die members also has an inner surface shaped to define one or more outwardly facing cavities. Further, each of the insert die members has a contact rim to substantially abut the exterior surface on an opposing one of the rotary die supports, and/or the contact rim of an opposing one of the insert die members securely engaging the opposing one of the rotary die supports, with the ribbons substantially juxtaposed therebetween. With the aforesaid rotation of the rotary die supports, each of the ribbons moves in a respective one of the rotary directions to between the adjacent pair of rotary die supports, and each said contact rim is in turn brought into the aforesaid substantial abutment. A single web of gel material is formed from the ribbons, with the cavities of the insert die members forming encapsulated pocket portions therewithin. The encapsulated pocket portions are filled with the fill material.

According to an aspect of one preferred embodiment of the invention, the apertures may preferably be formed in both of, and each of the insert die members may preferably securely engage a respective one of, the rotary die supports.

According to an aspect of one preferred embodiment of the invention, the aforesaid each aforesaid contact rim may preferably, but need not necessarily, be in registration with the contact rim of the aforesaid opposing one of the insert die members securely engaging the aforesaid opposing one of the rotary die supports. Two of the cavities, preferably one on each of the rotary die supports, may preferably, but need not necessarily, together form one of the encapsulated pocket portions.

According to an aspect of one preferred embodiment of the invention, each of the rotary die supports may preferably, but need not necessarily, be substantially cylindrical. The longitudinal axis of each one of the rotary die supports may preferably, but need not necessarily, be parallel to the longitudinal axis of each other one of the rotary die supports.

According to an aspect of one preferred embodiment of the invention, the inner surface of each of the insert die members may preferably, but need not necessarily, define each of the outwardly facing cavities as at least a segment of a capsular and/or ellipsoidal shape.

According to an aspect of one preferred embodiment of the invention, the inner surface of each of the insert die members may preferably, but need not necessarily, define each of the outwardly facing cavities as a hemi-spherical shape.

According to an aspect of one preferred embodiment of the invention, the inner surface of each of the insert die members may preferably, but need not necessarily, define each of the outwardly facing cavities as a substantially cylindrical shape, preferably with a hemi-ellipsoidal shape capping an inward end portion of the cylindrical shape.

According to an aspect of one preferred embodiment of the invention, the contact rim of each of the insert die members may preferably, but need not necessarily, have an annular contact surface. The contact surface may preferably, but need not necessarily, be substantially planar and/or part-cylindrical.

According to an aspect of one preferred embodiment of the invention, preferably inwardly of the contact rim, the outer surface of each of the insert die members may preferably, but need not necessarily, define a first tapering portion. Preferably adjacent the apertures, the exterior surface may preferably, but need not necessarily, be shaped to define a second tapering portion. The second tapering portion may preferably, but need not necessarily, securely engage the first tapering portion, preferably in substantially mating relation and/or in said selectively removable relation.

According to an aspect of one preferred embodiment of the invention, the device may preferably, but need not necessarily, also include one or more fastening elements. The fastening elements may preferably, but need not necessarily, be provided on the rotary die supports and/or on the outer surface of the insert die members. The fastening elements may preferably, but need not necessarily, enable the insert die members to be securely engageable with, and/or selectively removable from, the rotary die supports. The fastening elements may preferably, but need not necessarily, be selected from the group including: mating threadably engaging fastening elements; mating tabbed and notched fastening elements; interference fit fastening elements; and/or adhesives.

According to an aspect of one preferred embodiment of the invention, the apertures may preferably, but need not necessarily, extend all of the way through the wall of said at least one of the rotary die supports.

According to an aspect of one preferred embodiment of the invention, the device may preferably, but need not necessarily, also include an injection wedge located between the rotary die supports, preferably to dispense the fill material into the encapsulated pocket portions.

According to an aspect of one preferred embodiment of the invention, the fill material may preferably, but need not necessarily, be selected from a group which includes paintball fill materials, bath bead fill materials, pharmaceutical materials, and/or nutraceutical materials.

According to an aspect of one preferred embodiment of the invention, the aforesaid each aforesaid contact rim may preferably, but need not necessarily, be located in raised relation (preferably in a radially outward direction) above the exterior surface of the aforesaid respective one of the rotary die supports.

According to the invention, there are also disclosed insert die members for use with a pair of rotary die supports, a pair of gel ribbons, and a fill material to form gel capsules. The pair of rotary die supports are adjacent to one another and rotate towards one another in opposing rotary directions. Each of the rotary die supports has an exterior surface. The exterior surface of at least one of the rotary die supports is shaped to define one or more outwardly facing apertures. Each of the insert die members includes an outer surface, an inner surface and a contact rim. The outer surface extends into a respective one of the apertures and securely engages a respective one of the rotary die supports in selectively removable relation. The inner surface is shaped to define one or more outwardly facing cavities. The contact rim substantially abuts the exterior surface on an opposing one of the rotary die supports, and/or the contact rim of an opposing one of the insert die members securely engaging an opposing one of the rotary die supports, with the ribbons substantially juxtaposed therebetween. With the aforesaid rotation of the rotary die supports, each of the ribbons moves in a respective one of the rotary directions to between the adjacent pair of rotary die supports, and each said contact rim is in turn brought into the aforesaid substantial abutment. A single web of gel material is formed from the ribbons, with the cavities of the insert die members forming encapsulated pocket portions therewithin. The encapsulated pocket portions are filled with the fill material.

According to an aspect of one preferred embodiment of the invention, the inner surface of each of the insert die members may preferably, but need not necessarily, define each of the outwardly facing cavities as at least a segment of a capsular and/or ellipsoidal shape.

According to an aspect of one preferred embodiment of the invention, the inner surface of each of the insert die members may preferably, but need not necessarily, define each of the outwardly facing cavities as a hemi-spherical shape.

According to an aspect of one preferred embodiment of the invention, the inner surface of each of the insert die members may preferably, but need not necessarily, define each of the outwardly facing cavities as a substantially cylindrical shape, preferably with a hemi-ellipsoidal shape capping an inward end portion of the cylindrical shape.

According to an aspect of one preferred embodiment of the invention, the contact rim of each of the insert die members may preferably, but need not necessarily, have an annular contact surface. The contact surface may preferably, but need not necessarily, be substantially planar and/or part-cylindrical.

According to the invention, there is also disclosed a method of using a fill material, a pair of gel ribbons, a pair of rotary die supports and one or more insert die members to form encapsulated pocket portions in a web of gel material. The method includes step (a) of extending an outer surface of one of the insert die members into an outwardly facing aperture which is defined by an exterior surface of one of the rotary die supports. In step (a), the outer surface securely engages the aforesaid one of the rotary die supports in selectively removable relation. The method also includes step (b) of: rotating the pair of rotary die supports in opposing rotary directions; moving the pair of gel ribbons in the opposing rotary directions to between the pair of rotary die supports; and bringing a contact rim of the aforesaid one of the insert die members into substantial abutment with the exterior surface on an opposing one of the rotary die supports, and/or with the contact rim of an opposing one of the insert die members securely engaging the opposing one of the rotary die supports, with the ribbons substantially juxtaposed therebetween. And, the method includes step (c) of forming the web of gel material from the ribbons, and forming the encapsulated pocket portions within the web using outwardly facing cavities which are defined by an inner surface of each of the insert die members, with the encapsulated pocket portions filled with the fill material.

According to an aspect of one preferred embodiment of the invention, the method may preferably also include step (a.1), preferably before step (b), of extending the outer surface of the opposing one of the insert die members into the outwardly facing aperture defined by the exterior surface of the opposing one of the rotary die supports, preferably with the outer surface securely engaging the opposing one of the rotary die supports in selectively removable relation. Preferably in step (b), the contact rim of the aforesaid one of the insert die members may preferably, but need not necessarily, be brought into substantial abutment with the contact rim of the opposing one of the insert die members, preferably with the ribbons substantially juxtaposed therebetween. Preferably in step (c), two of the cavities, preferably one on each of the rotary die supports, preferably together form one of the encapsulated pocket portions.

According to an aspect of one preferred embodiment of the invention, preferably in step (c), each of the encapsulated pocket portions may preferably, but need not necessarily, define at least a segment of a capsular and/or ellipsoidal shape.

According to an aspect of one preferred embodiment of the invention, preferably in step (c), at least one of the encapsulated pocket portions may preferably, but need not necessarily, define a spherical shape.

According to an aspect of one preferred embodiment of the invention, preferably before step (a), a first tapering portion may preferably, but need not necessarily, be defined inwardly of the contact rim, preferably by the outer surface of the aforesaid one of the insert die members. And, preferably before step (a), a second tapering portion may preferably, but need not necessarily, be defined adjacent the outwardly facing aperture, preferably by the exterior surface of the aforesaid one of the rotary die supports. Preferably in step (a), the first tapering portion securely may preferably, but need not necessarily, engage the second tapering portion, preferably in substantially mating relation and/or in the aforesaid selectively removable relation.

According to an aspect of one preferred embodiment of the invention, preferably before step (a), one or more fastening elements may preferably, but need not necessarily, be provided on the aforesaid one of the rotary die supports and/or on the outer surface of the aforesaid one of the insert die members. The fastening elements may preferably, but need not necessarily, be selected from a group which includes: mating threadably engaging fastening elements, mating tabbed and notched fastening elements, interference fit fastening elements, and/or adhesives. Preferably in step (a), the fastening elements may preferably, but need not necessarily, enable the aforesaid one of the insert die members to securely engage the aforesaid one of the rotary die supports, preferably in selectively removable relation.

According to an aspect of one preferred embodiment of the invention, preferably in step (c), an injection wedge may preferably, but need not necessarily, be located between the rotary die supports and may preferably, but need not necessarily, dispense the fill material into the encapsulated pocket portions.

According to an aspect of one preferred embodiment of the invention, preferably in step (c), the method may preferably, but need not necessarily, be for use with a paintball fill material, a bath bead fill material, a pharmaceutical material and/or a nutraceutical material.

According to an aspect of one preferred embodiment of the invention, preferably in step (a), the contact rim of the aforesaid one of the insert die members may preferably, but need not necessarily, be located in raised relation, preferably in a radially outward direction, above the exterior surface of the aforesaid one of the rotary die supports.

According to an aspect of one preferred embodiment of the invention, the method may also preferably include step (d), preferably after step (c), of removing the outer surface of the aforesaid one of the insert die members from the aforesaid secure engagement with the aforesaid one of the rotary die supports. Preferably in step (d), the outer surface of the aforesaid one of the insert die members may preferably, but need not necessarily, be withdrawn from the aperture in the aforesaid one of the rotary die supports.

Other advantages, features and characteristics of the present invention, as well as methods of operation and functions of the related elements of the methods and devices, and the combination of steps, parts and economies of manufacture, will become more apparent upon consideration of the following detailed description and the appended claims with reference to the accompanying drawings, the latter of which are briefly described hereinbelow.

### BRIEF DESCRIPTION OF THE DRAWINGS

The novel features which are believed to be characteristic of the devices and methods according to the present invention, as to their structure, organization, use, and method of operation, together with further objectives and advantages thereof, will be better understood from the following drawings in which presently preferred embodiments of the invention will now be illustrated by way of example. It is expressly understood, however, that the drawings are for the purpose of illustration and description only, and are not intended as a definition of the limits of the invention. In the accompanying drawings:

FIG. 1 is a schematic drawing of a rotary die support and insert die member device and method for manufacturing gel capsules according to the invention;

FIG. 2 is a schematic drawing of one of the rotary die supports shown in FIG. 1;

FIG. 3 is a schematic drawing of an insert die member of the device and method shown in FIG. 1;

FIG. 3A is enlarged view of encircled area 3A shown in FIG. 3;

FIG. 4 is a sectional view of an injection wedge, rotary die supports, insert die members, and web of gel material shown in FIG. 1;

FIG. 5 is a sectional view of one of the rotary dies shown in FIG. 4, with the insert die members shown removed therefrom;

FIG. 6 is a sectional view similar to FIG. 5, showing an alternate rotary die support according to the invention, and one removed insert die member;

FIG. 7A is a sectional view of the insert die member shown in FIG. 6;

FIG. 7B is a sectional view similar to FIG. 7A, showing an alternate insert die member according to the invention;

FIG. 8A is a sectional view of a rotary die support and an insert die member according to the invention, showing threadably engaging fastening elements; and

FIG. 8A is a sectional view of a rotary die support and an insert die member according to the invention, showing tabbed and notched fastening elements.

### DETAILED DESCRIPTION OF THE PREFERRED EMBODIMENTS

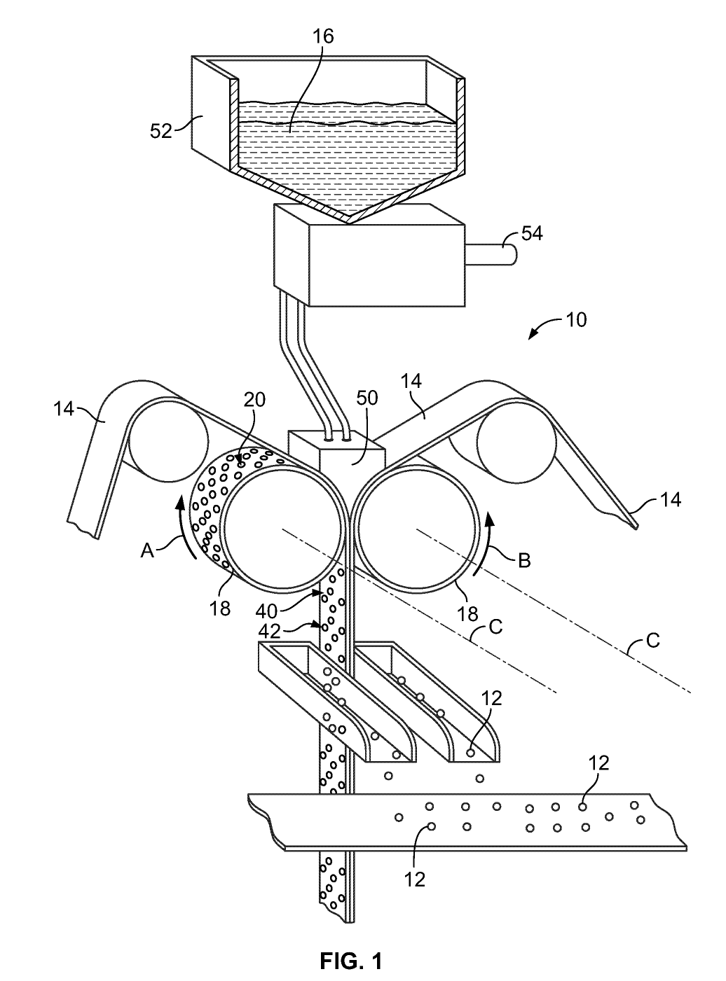

Referring to FIG. 1 of the drawings, there is shown a rotary die support and insert die member device 10 for forming gel capsules 12 according to one embodiment of the invention. The rotary die support and insert die member device 10 is for use with a pair of gel ribbons 14 and a fill material 16.

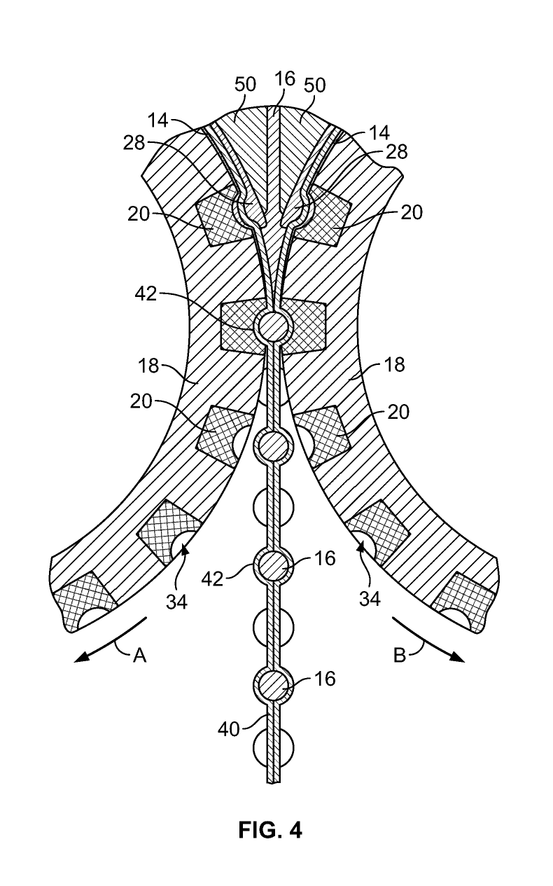

As shown in FIG. 1, the rotary die support and insert die member device 10 includes an adjacent pair of rotary die supports 18. Preferably, and as best seen in FIG. 4, the device 10 also includes a plurality of insert die members 20 associated with the rotary die supports 18.

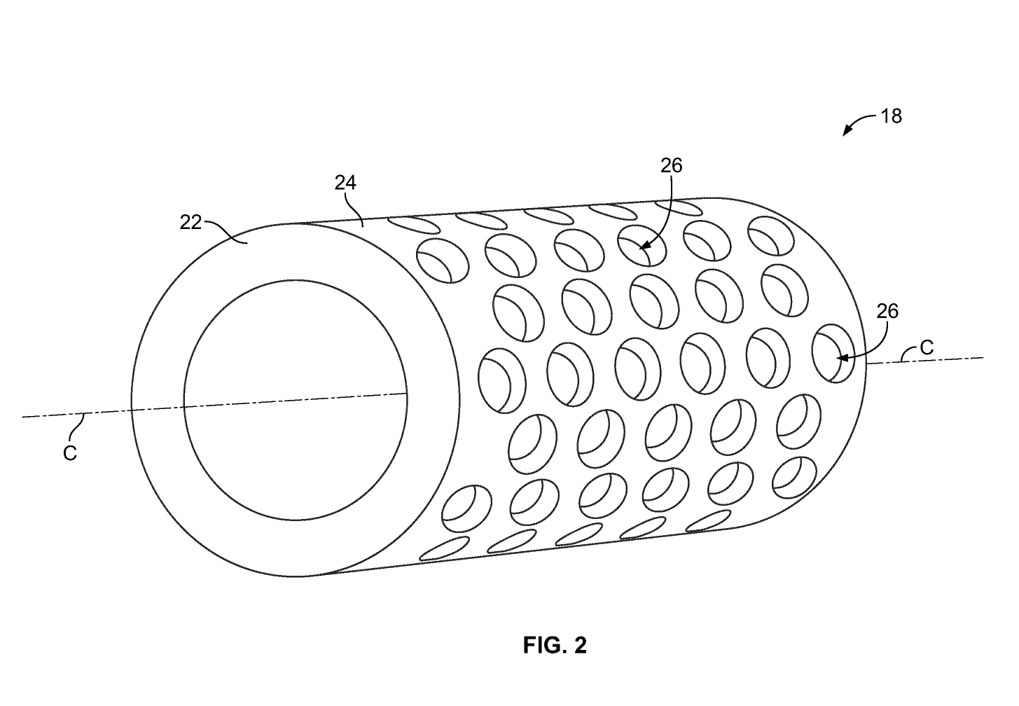

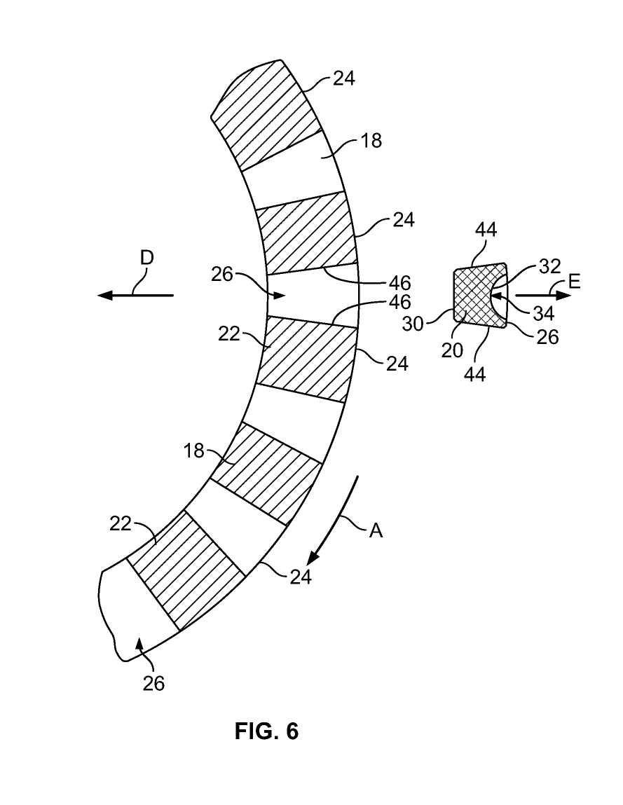

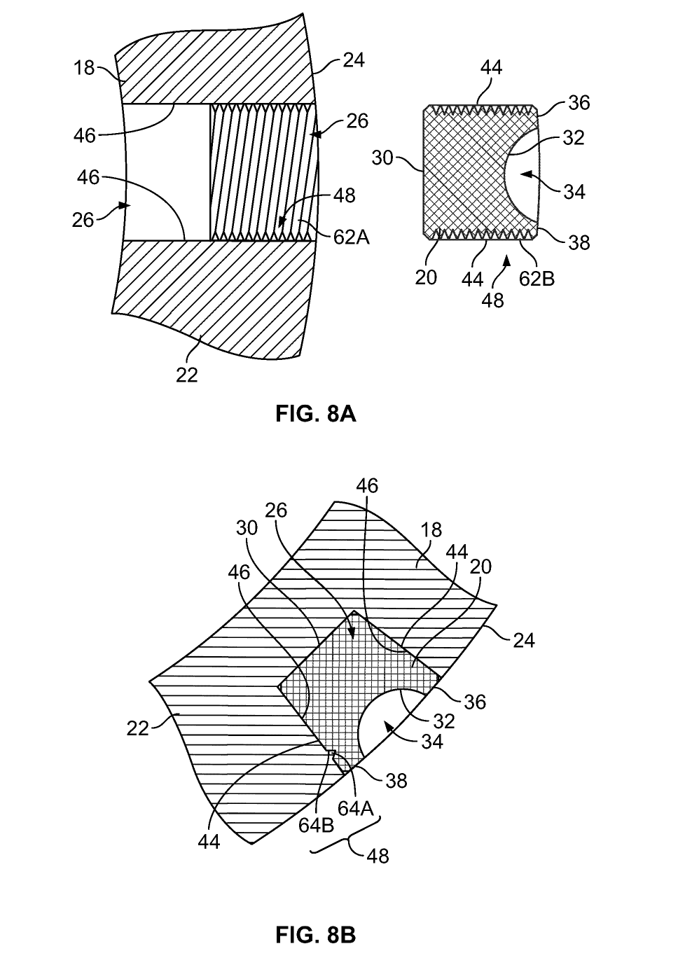

The rotary die supports 18 are configured to rotate towards one another in opposing rotary directions when in operation (as indicated generally by arrows “A” and “B” in FIGS. 1 and 4). As shown in FIG. 2, each of the rotary die supports 18 has a wall 22 with an exterior surface 24 which is preferably shaped to define outwardly facing apertures 26. The apertures 26 may extend partially through the wall 22 (as shown in FIGS. 4, 5 and 8B), or completely through the wall 22 (as shown in FIGS. 6 and 8A), of at least one of the rotary die supports 18.

As shown in FIGS. 1 and 2, each of the rotary die supports 18 defines a longitudinal axis “C”. Each of the rotary die supports 18 is preferably substantially cylindrical, with the longitudinal axes “C” thereof being substantially parallel to one another (as best seen in FIG. 1). One skilled in the art will recognize that the rotary die supports 18 may be of a different configuration—e.g., substantially conical rotary die supports 18 with the longitudinal axes “C” set at an angle relative to one another to maintain the exterior surfaces 24 thereof in substantial contact with each other.

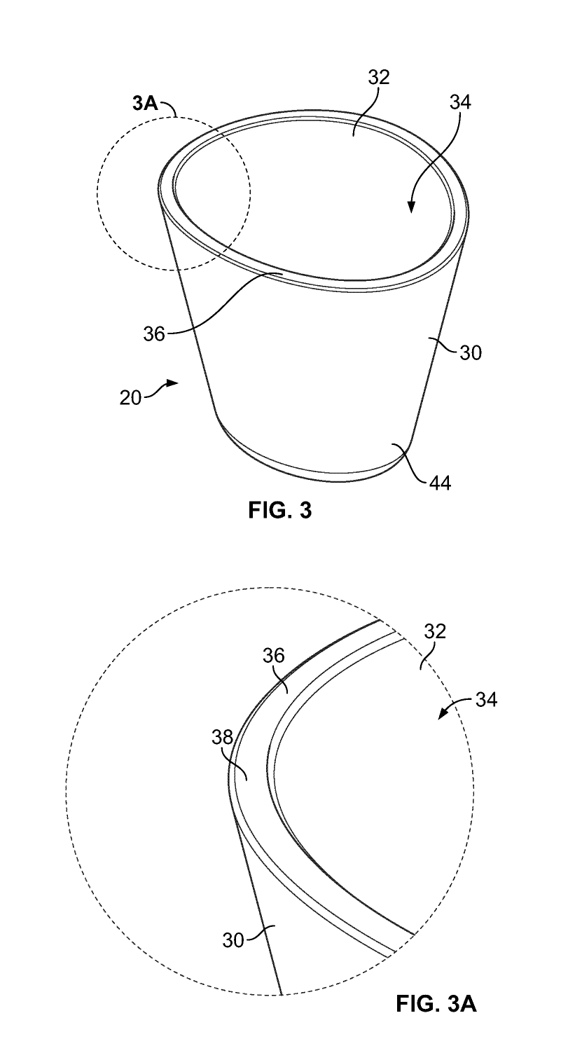

As best shown in FIGS. 3 and 4, each of the insert die members 20 has an outer surface 30. As best shown in FIG. 4, each outer surface 30 extends into a respective one of the apertures 26 and securely engages a respective one of the rotary die supports 18 in selectively removable relation. In FIG. 4, the apertures 26 are shown as preferably being formed in both rotary die supports 18, with each of the insert die members 20 securely engaging a respective one of the rotary die supports 18.

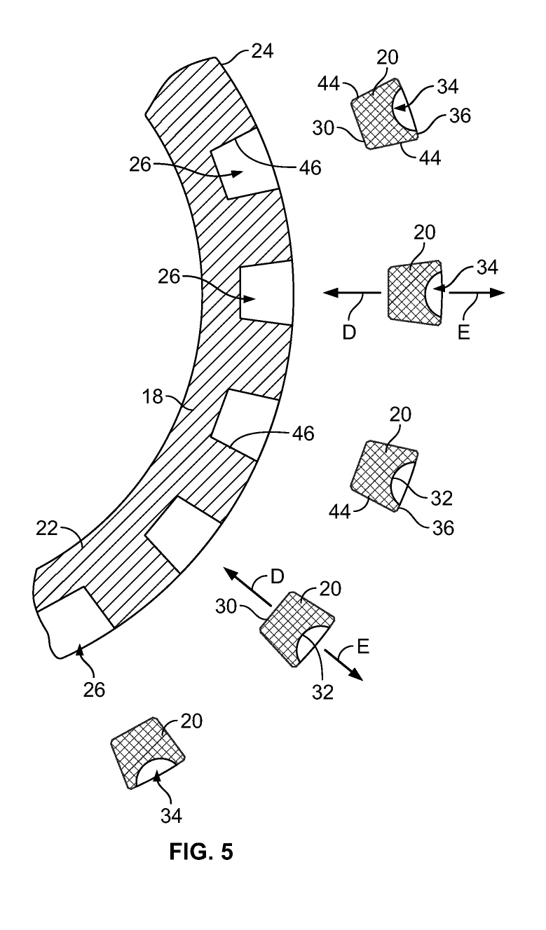

Each of the insert die members 20 is additionally provided with an inner surface 32 shaped to define one or more outwardly facing cavities 34, and a contact rim 36. The contact rim 36 of the insert die member 20 is preferably mounted in raised relation—in a radially outward direction (as indicated generally by arrow “E” in FIGS. 5 and 6) —above the exterior surface 24 of the rotary die support 18 on which it is mounted.

In operation, and as may be best appreciated from a consideration of FIG. 4, the contact rims 36 on opposing insert die members 20 (securely engaging opposing rotary die supports 18) substantially abut one another, with the ribbons 14 juxtaposed therebetween. Alternately, the contact rim 36 on one insert die member 20 may substantially abut the exterior surface 24 on the opposing rotary die support 18 (with the ribbons 14 juxtaposed therebetween).

In use, the rotary die supports 18 are rotated in opposing rotary directions, “A” and “B”, as described hereinabove. Each of the ribbons 14 moves in a respective one of the rotary directions “A” and “B” to a position between the adjacent pair of rotary die supports 18. Each of the contact rims 36 is, in turn, brought into the aforesaid substantial abutment, with the ribbons 14 preferably being substantially juxtaposed between the contact rims 36 of insert die members 20 mounted on opposing rotary die supports 18.

Each contact rim 36 is preferably brought into registration with a contact rim 36 on an opposing insert die member 20 securely engaging the opposing rotary die support 18. The contact rim 36 of each insert die member 20 may preferably have an annular contact surface 38, as may be best appreciated from a consideration of FIGS. 3 and 3B. The annular contact surface 38 is preferably substantially planar and/or part-cylindrical (e.g., a two-dimensional surface curving about the longitudinal axis “C”), preferably to maximize contact between opposing contact rims 26 and properly form the gel capsules 12.

Preferably, rotation of the die supports 18 may draw or help to draw the ribbons 14 in the rotary directions, “A” and “B”. (According to some alternate embodiments which are within the scope of the present invention, the ribbons 14 may urge or help to urge the rotary die supports 18 in the rotary directions, “A” and “B”.) In any event, and as may be best appreciated from a consideration of FIG. 4, an oil bead 28 is preferably squeezed out from between each ribbon 14 and the exterior surface 24 of the rotary die support 18, as the ribbons 14 are substantially juxtaposed between the contact rims 36 with rotation of the die supports 18.

In this manner, a single web of gel material 40 is formed from the ribbons 14, with the cavities 34 of the insert die members 20 forming encapsulated pocket portions 42 within the web 40. As shown in FIG. 4, each encapsulated pocket portion 42 is formed by two cavities 34 (one carried by each of the rotary die supports 18).

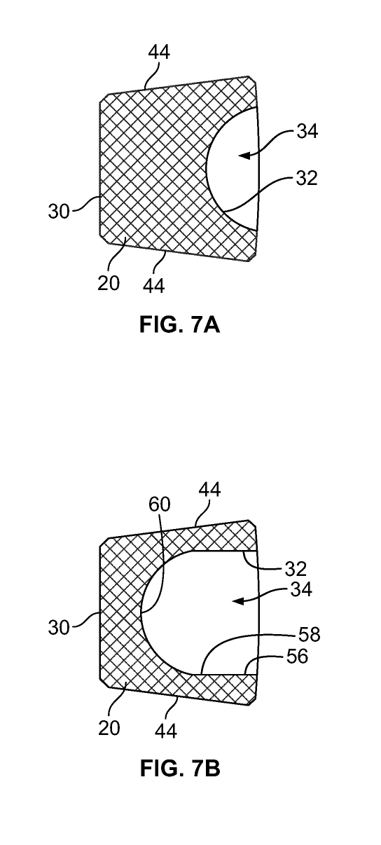

Now turning to FIG. 3, one of the insert die members 20 is shown. As shown in FIGS. 3-8B, the inner surface 32 of each insert die member 20 preferably defines the outwardly facing cavity 34 as at least a segment of a capsular and/or ellipsoidal shape. Ellipsoid shapes include spheroid shapes, among others. A hemi-ellipsoid shape is one possible type of segment of an ellipsoid shape. As shown in FIGS. 4-7A and 8A-8B, a segment of an ellipsoid shape may be a half-sphere or a hemi-spherical shape. This configuration allows for the formation of substantially spherical capsules, such as paintballs for instance. Apart from ellipsoid shapes, a segment of a capsular shape will include a substantially cylindrical shape 56 capped at one end 58 by a segment of an ellipsoid shape 60 (as shown in FIG. 7B). This configuration is adapted for producing substantially oblong capsules, such as suppositories. Persons having ordinary skill in the art will appreciate that it is also within the scope of the present invention for a contact rim 36 to substantially abut the exterior surface 24 of the opposing rotary die support 18, such that the device 10 may be adapted to form hemi-spherical capsules or substantially flat-ended capsular shapes. The device 10 may therefore be advantageously converted from forming spherical capsules to forming oblong ones by simply substituting insert die members 20 having cavities 34 of one shape for those having cavities 34 of another shape.

Inwardly of the contact rim 36, the outer surface 30 of the insert die members 20 may preferably define a first tapering portion 44. Adjacent the apertures 26, and as best seen in FIGS. 5, 6 and 8B, the exterior surface 24 is preferably similarly shaped to define a second tapering portion 46. In operation, the first tapering portion 44 securely engages the second tapering portion 46 in substantially mating relation and in selectively removable relation.

The device 10 may preferably also be provided with fastening elements 48 on the rotary die supports 18 and on the outer surface 30 of the insert die members 20. The fastening elements 48 preferably enable the insert die members 20 to securely engage the rotary die supports 18 in selectively removable relation. According to the invention, the fastening elements 48 may include: mating threadably engaging fastening elements, 62A and 62B (as shown in FIG. 8A); mating tabbed and notched fastening elements, 64A and 64B (as shown in FIG. 8B); interference fit fastening elements (as may be best appreciated from a consideration of FIGS. 4-6); and adhesives (not shown). Alternately, insert die members 20 may securely and removably engage the rotary die supports 18 by means that would be obvious to persons skilled in the relevant art in view of the common general knowledge. Preferably, however, the insert die members 20 engaging the rotary die supports 18 will be capable of withstanding the pressure and/or forces sustained during normal operation of the device 10.

As shown in FIGS. 1 and 4, the fill material 16 is preferably dispensed into the encapsulated pocket portions 42 by an injection wedge 50 located between the rotary die supports 18. The fill material 16 is preferably pumped from a reservoir 52, by a fill pump 54, to the injection wedge 50. The fill material 16 is preferably, but not necessarily, a paintball fill material, a bath bead fill material, a pharmaceutical material and/or a nutraceutical material. Of course, other suitable materials may additionally and/or instead be used as the fill material 16.

A method for forming the gel capsules 12 using the pair of ribbons 14 and the fill material 16 according to one embodiment as contemplated by the inventor will now be briefly described with references to the figures. It will be appreciated by persons skilled in the art that the method outlined hereinbelow is but one such method which falls within the scope of the invention as circumscribed by the claims. In the following description, the same reference numerals have been used to indicate various components, surfaces, materials, relations, directions, and configurations which are common to both the method and the device 10 (described above) of the present invention. It should, however, be appreciated that, although some of the components, surfaces, materials, relations, directions, and configurations of the device 10 are not specifically referenced in the following description of the method, they may be used, and/or adapted for use, in association therewith.

The outer surfaces 30 of the insert die members 20 preferably extend—in a radially inward direction (as indicated generally by arrow “D” in FIGS. 5 and 6) —into the apertures 26 of respective rotary die supports 18. The outer surfaces 30 of the insert die members 20 are preferably securely engaged in the respective rotary die supports 18. According to some preferred embodiments of the invention, the fastening elements 48 are preferably used to removably secure the outer surfaces 30 of the insert die members 20 to the rotary die supports 18.

Preferably, the rotary die supports 18 are rotated in the opposing rotary directions, “A” and “B”. The ribbons 14 are moved in the rotary directions, “A” and “B”, to between the rotary die supports 18. Contact rims 26 of insert die members 20 on opposing rotary die supports 18 are preferably brought into substantial abutment with one another, with the ribbons 14 substantially juxtaposed between the contact rims 36.

Preferably, the ribbons 14 substantially merge between the contact rims 36 to form the web of gel material 40. The cavities 34 of insert die members 20 on opposing rotary die supports 18 preferably form the encapsulated pocket portions 42. The fill material 16 is dispensed into the encapsulated pocket portions 42—preferably by action of the fill pump 54, drawing the fill material 16 from the reservoir 52, and dispensing it through the injection wedge 50.

The web 40 with the encapsulated pocket portions 42 is preferably moved away from the rotary die supports 18. As may be well known in the art, the encapsulated pocket portions 42 may be subsequently separated from the web 40 to form the gel capsules 12. The gel capsules 12 may now then subjected to further operations, such as drying and/or coloring.

According to the invention, when maintenance and/or replacement of one or more selected insert die members 20 is desired and/or required—e.g., for replacement of worn and/or damaged landing surfaces (alternately referred to herein as contact surfaces 38) and/or insert die members 20, for cleaning of the insert die members 20 and/or rotary die supports 18, for substitution of insert die members 20 having differently-shaped cavities—the outer surfaces 30 of the selected insert die members 20 are disengaged and selectively removed from secure engagement with the respective rotary dies 18. The selected insert die members 20 may then be withdrawn and/or removed from the respective rotary dies 18. If the insert die members 20 are fastened by fastening elements 48 to the respective rotary dies 18, then they may be unfastened prior to being removed therefrom.

The device 10 according to the present invention may advantageously eliminate and/or substantially minimize re-machining and/or grinding if damage and wear occurs. If the contact rim 26 on an insert die member 20 is damaged and/or worn, only that specific insert die member 20 need be replaced—instead of replacing both of the rotary die supports 18. This savings may result in a substantial reduction of the costs associated with the manufacturing of gel capsules 12. It may preferably be possible to replace damaged and/or worn insert die members 20 directly on the device 10, without having to remove the rotary die supports 18—potentially saving valuable production time. Replacing only damaged and/or worn insert die members 20 may take only seconds per insert die member 20. The insert die members 20 may all be substantially identical with one another. There may be no need to re-align the rotary die supports 18 and/or to re-time the injection wedge 50. Preferably, damaged and/or worn insert die members 20 may be recycled (e.g., ground down and/or re-formed into a new insert member if plastic, or melted down if aluminum) —potentially further reducing costs.

The rotary die supports 18 may preferably require less time to manufacture. They are preferably not provided with delicate landing surfaces manufactured directly into the exterior surfaces 24 thereof. The rotary die support 18 preferably may not come into contact with the opposing rotary die support 18. Preferably, any chance of daily damage and/or wear to the rotary die supports 18 may be virtually eliminated and/or substantially reduced. The rotary die supports 18 may preferably have a much longer lifespan, and an operator may preferably be required to keep only one set of rotary die supports 18 for each device 10.

Each insert die member 20 is dimensioned to produce the required shape, size and/or weight of the final product (e.g., gel capsules 12). The preferred insert die members 20 may be made from plastic, metal and/or any other material that may be adapted to withstand the pressures of operation. The preferred rotary die supports 18 may be made of aluminum, steel and/or any other material capable of withstanding the pressures of operation. One of the apertures 26 may be adapted and/or designed to accommodate a single insert die member 20 or a series of insert die members 20. The device 10 may be formed to produce various shapes and/or sizes of said shapes for the final product (e.g., gel capsules 12).

Other modifications and alterations may be used in the design and manufacture of other embodiments according to the present invention without departing from the spirit and the scope of the invention, which is limited only by the accompanying claims.

I claim:

1. A rotary die support and insert die device for forming gel capsules and for use with a pair of gel ribbons and a fill material, the device comprising:
a) an adjacent pair of rotary die supports to rotate towards one another in opposing rotary directions, each defining a longitudinal axis and each having a wall with an exterior surface, with the exterior surface of at least one of the rotary die supports being shaped to define one or more outwardly facing apertures extending at least partially through the wall; and
b) one or more insert die members, each having: an outer surface extending into a respective one of the apertures and securely engaging a respective one of the rotary die supports in selectively removable relation; an inner surface shaped to define one or more outwardly facing cavities; and a contact rim to substantially abut the exterior surface on an opposing one of the rotary die supports, and/or the contact rim of an opposing one of the insert die members securely engaging the opposing one of the rotary die supports, with the ribbons substantially juxtaposed therebetween;
wherein, with the aforesaid rotation of the rotary die supports, each of the ribbons moves in a respective one of the rotary directions to between the adjacent pair of rotary die supports, and each said contact rim is in turn brought into the aforesaid substantial abutment; wherein a single web of gel material is formed from the ribbons, with the cavities of the insert die members forming encapsulated pocket portions therewithin; and wherein the encapsulated pocket portions are filled with the fill material.

2. A device according to claim 1, wherein the apertures are formed in both of, and each of the insert die members securely engages a respective one of, the rotary die supports.

3. A device according to claim 2, wherein said each said contact rim is in registration with the contact rim of said opposing one of the insert die members securely engaging said opposing one of the rotary die supports; and wherein two of the cavities, one on each of the rotary die supports, together form one of the encapsulated pocket portions.

4. A device according to claim 1, wherein each of the rotary die supports is substantially cylindrical, and wherein the longitudinal axis of each one of the rotary die supports is parallel to the longitudinal axis of each other one of the rotary die supports.

5. A device according to claim 1, wherein the inner surface of each of the insert die members defines each of the outwardly facing cavities as at least a segment of a capsular and/or ellipsoidal shape.

6. A device according to claim 5, wherein the inner surface of each of the insert die members defines each of the outwardly facing cavities as a hemi-spherical shape.

7. A device according to claim 5, wherein the inner surface of each of the insert die members defines each of the outwardly facing cavities as a substantially cylindrical shape with a hemi-ellipsoidal shape capping an inward end portion of the cylindrical shape.

8. A device according to claim 1, wherein the contact rim of each of the insert die members has an annular contact surface, with the contact surface being substantially planar and/or part-cylindrical.

9. A device according to claim 1, wherein inwardly of the contact rim, the outer surface of each of the insert die members defines a first tapering portion; wherein adjacent the apertures, the exterior surface is shaped to define a second tapering portion securely engaging the first tapering portion in substantially mating relation and in said selectively removable relation.

10. A device according to claim 1, further comprising one or more fastening elements provided on the rotary die supports and on the outer surface of the insert die members; wherein the fastening elements enabling the insert die members to be securely engageable with, and selectively removable from, the rotary die supports; and wherein the fastening elements are selected from the group consisting of: mating threadably engaging fastening elements; mating tabbed and notched fastening elements; interference fit fastening elements; and adhesives.

11. A device according to claim 1, wherein the apertures extend all of the way through the wall of said at least one of the rotary die supports.

12. A device according to claim 1, further comprising an injection wedge located between the rotary die supports to dispense the fill material into the encapsulated pocket portions.

13. A device according to claim 1, wherein the fill material is selected from a group consisting of paintball fill materials, bath bead fill materials, pharmaceutical materials and nutraceutical materials.

14. A device according to claim 1, wherein said each said contact rim is located in raised relation, in a radially outward direction, above the exterior surface of said respective one of the rotary die supports.

15. Insert die members for use with a pair of rotary die supports, a pair of gel ribbons, and a fill material to form gel capsules, with the pair of rotary die supports being adjacent to one another and rotating towards one another in opposing rotary directions, with each of the rotary die supports having an exterior surface, and with the exterior surface of at least one of the rotary die supports being shaped to define one or more outwardly facing apertures, with each of the insert die members comprising:
a) an outer surface to extend into a respective one of the apertures and securely engage a respective one of the rotary die supports in selectively removable relation;
b) an inner surface shaped to define one or more outwardly facing cavities; and
c) a contact rim to substantially abut the exterior surface on an opposing one of the rotary die supports, and/or the contact rim of an opposing one of the insert die members securely engaging an opposing one of the rotary die supports, with the ribbons substantially juxtaposed therebetween;
wherein, with the aforesaid rotation of the rotary die supports, each of the ribbons moves in a respective one of the rotary directions to between the adjacent pair of rotary die supports, and each said contact rim is in turn brought into the aforesaid substantial abutment; wherein a single web of gel material is formed from the ribbons, with the cavities of the insert die members forming encapsulated pocket portions therewithin; and wherein the encapsulated pocket portions are filled with the fill material.

16. Insert die members according to claim 15, wherein the inner surface of each of the insert die members defines each of the outwardly facing cavities as at least a segment of a capsular and/or ellipsoidal shape.

17. Insert die members according to claim 16, wherein the inner surface of each of the insert die members defines each of the outwardly facing cavities as a hemi-spherical shape.

18. Insert die members according to claim 16, wherein the inner surface of each of the insert die members defines each of the outwardly facing cavities as a substantially cylindrical shape with a hemi-ellipsoidal shape capping an inward end portion of the cylindrical shape.

19. Insert die members according to claim 15, wherein the contact rim of each of the insert die members has an annular contact surface, with the contact surface being substantially planar and/or part-cylindrical.

20. A method of using a fill material, a pair of gel ribbons, a pair of rotary die supports and one or more insert die members to form encapsulated pocket portions in a web of gel material, the method comprising the steps of:
a) extending an outer surface of one of the insert die members into an outwardly facing aperture which is defined by an exterior surface of one of the rotary die supports, with the outer surface securely engaging said one of the rotary die supports in selectively removable relation;
b) rotating the pair of rotary die supports in opposing rotary directions; moving the pair of gel ribbons in the opposing rotary directions to between the pair of rotary die supports; and bringing a contact rim of said one of the insert die members into substantial abutment with the exterior surface on an opposing one of the rotary die supports, and/or with the contact rim of an opposing one of the insert die members securely engaging the opposing one of the rotary die supports, with the ribbons substantially juxtaposed therebetween; and
c) forming the web of gel material from the ribbons, and forming the encapsulated pocket portions within the web using outwardly facing cavities which are defined by an inner surface of each of the insert die members, with the encapsulated pocket portions filled with the fill material.

21. A method according to claim 20, further comprising step (a.1), before step (b), of extending the outer surface of the opposing one of the insert die members into the outwardly facing aperture defined by the exterior surface of the opposing one of the rotary die supports, with the outer surface securely engaging the opposing one of the rotary die supports in selectively removable relation; wherein in step (b), the contact rim of said one of the insert die members is brought into substantial abutment with the contact rim of the opposing one of the insert die members, with the ribbons substantially juxtaposed therebetween; and wherein in step (c), two of the cavities, one on each of the rotary die supports, together form one of the encapsulated pocket portions.

22. A method according to claim 20, wherein in step (c), each of the encapsulated pocket portions defines at least a segment of a capsular and/or ellipsoidal shape.

23. A method according to claim 22, wherein in step (c), at least one of the encapsulated pocket portions defines a spherical shape.

24. A method according to claim 20, wherein before step (a), a first tapering portion is defined inwardly of the contact rim by the outer surface of said one of the insert die members, and a second tapering portion is defined adjacent the outwardly facing aperture by the exterior surface of said one of the rotary die supports; and wherein in step (a), the first tapering portion securely engages the second tapering portion in substantially mating relation and in said selectively removable relation.

25. A method according to claim 20, wherein before step (a), one or more fastening elements are provided on said one of the rotary die supports and on the outer surface of said one of the insert die members, with the fastening elements being selected from the group consisting of mating threadably engaging fastening elements, mating tabbed and notched fastening elements, interference fit fastening elements, and adhesives; and wherein in step (a), the fastening elements enable said one of the insert die members to securely engage said one of the rotary die supports, in selectively removable relation.

26. A method according to claim 20, wherein in step (c), an injection wedge is located between the rotary die supports and dispenses the fill material into the encapsulated pocket portions.

27. A method according to claim 20, for use with a paintball fill material, a bath bead fill material, a pharmaceutical material and/or a nutraceutical material in step (c).

28. A method according to claim 20, wherein in step (a), the contact rim of said one of the insert die members is located in raised relation, in a radially outward direction, above the exterior surface of said one of the rotary die supports.

29. A method according to claim 20 further comprising step (d), after step (c), of removing the outer surface of said one of the insert die members from the aforesaid secure engagement with said one of the rotary die supports, and withdrawing the outer surface of said one of the insert die members from the aperture in said one of the rotary die supports.
